(19) United States
(12) Patent Application Publication
(10) Pub. No.: US 2015/0038626 A1
(43) Pub. Date: Feb. 5, 2015

(54) STABILIZER COMPOSITIONS FOR THERMOPLASTIC POLYMERS

(71) Applicants: Peter Daute, Beverstedt (DE); Jurgen Waldmann, Langenfeld (DE)

(72) Inventors: Peter Daute, Beverstedt (DE); Jurgen Waldmann, Langenfeld (DE)

(73) Assignee: AMRIL AG, Zug (CH)

(21) Appl. No.: 14/358,985

(22) PCT Filed: Jan. 23, 2012
(86) PCT No.: PCT/EP2012/000291

§ 371 Date: Sep. 12, 2014

(51) Int. Cl. C08K 5/00; B29C 43/24; C09K 15/06; C08K 5/103; C08J 5/00

(52) U.S. Cl. CPC C08K 5/0091; C08K 5/103; C08J 5/00; C09K 15/06; B29C 43/24; C08J 2327/06; B29K 2027/06
USPC 524/306; 252/400.1; 252/400.52; 264/175

(57) ABSTRACT

The present invention relates to a composition comprising a metal complex of a 1,3-diketone and an optionally substituted full ester of a monool or a diol and a monocarboxylic acid; wherein a mixture consisting of (a) and (b) has a viscosity of less or equal than 40 mPa·s when measured at 80° C.

The present invention relates to compositions comprising at least (a) a metal complex of a 1,3-diketone and (b) an optionally substituted full ester of a monool or a diol and a monocarboxylic acid, wherein a mixture consisting of (a) and (b) has a viscosity of less or equal than 40 mPa·s when measured at 80° C. and methods for production and uses thereof.

### BACKGROUND OF THE INVENTION

Thermoplastic polymers such as PVC can be stabilized by a number of additives. Such stabilizers effectively reduce decomposition reactions occurring in thermoplastic compositions when the composition is exposed to excessive heat during processing.

Compounds of lead, tin, barium and cadmium are especially suitable for the purpose but are controversial today for ecological reasons or owing to their toxic metal content (cf. “Kunstoffadditive” (Plastics additives), R. Gachterl-H. Muller, Carl Hanser Verlag, 3rd Edition, 1989, pages 303-311, and “Kunststoff Handbuch PVC” (Plastics Handbook PVC), Volume 2/1, W. Becker/D. Braun, Carl Hanser Verlag, 2nd Edition, 1985, pages 531-538; and Kirk-Othmer: “Encyclopedia of Chemical Technology”, 4th Ed., 1994, Vol 12, Heat Stabilizers p. 1071-1091).

Other effective stabilizers and stabilizer combinations that are free of lead, barium, tin and cadmium were therefore sought. Stabilizers based on calcium and zinc were found and analyzed (see e.g. EP 0 686 139 A1, EP 0 336 289 and U.S. Pat. No. 5,010,123). Such stabilizers were successfully used in many fields. For example, PVC bottles for drinking water, pipes and profiles have been produced without toxic metal stabilizers.

The production of calendered films based on Ca/Zn-stabilizers does not present any problems, provided the films are opaque. However, the production of transparent or glass—clear films without toxic metal stabilizers is difficult, since Ca/Zn-based stabilizers tend to induce discoloration in the final product. Thus, non-toxic stabilizers are needed which maintain a stable or persistent early color in the product and which do not significantly decrease the long term stability of the respective products.

For example, a rigid thermoplastic polymer such as a halogenated polyolefin is required to have a good early color in the shaped article industry. Shaped article manufacture differs from pipe manufacture in that the shaped article cross-sections can be extremely complex and are often made with extremely thin walls. In addition, shaped articles generally require a good finish which frequently necessitates the addition of various modifiers which increase the viscosity of the PVC melt and complicate material flow. In this case, the known Ca/Zn stabilizers and added epoxides are not sufficient for effective stabilization, nor are additions of co-stabilizers, such as polyols or sodium aluminium silicates. Thus, there is a need for stabilizer compositions and in particular for stabilizer compositions which are free of toxic metals.

Typically further additives will be admixed to stabilizer compositions such as fillers, flame retardants, antiblock agents. Such addition however increases the viscosity of the composition, making handling and confectioning difficult. Thus, it was one object of the invention to reduce the viscosity of the stabilizer composition of the invention for easier handling while still having potent stabilizing qualities. The above mentioned prior art Ca/Zn stabilizer compositions were in contrast not optimized for low viscosity.

The present invention is a stabilizer composition for thermoplastic polymers and in particular for thermoplastic polymers which are based on chlorine-containing olefins, that provides the polymers with the following advantageous properties:

1. absence of toxic metals such as lead, barium, tin and cadmium,

2. stable or persistent early color,

3. no discoloration at relatively high temperatures for the period of time required for the production of shaped articles,

4. reduced viscosity of the stabilizer composition for easier handling, confectioning and transport of the composition.

### SUMMARY OF THE INVENTION

The present invention provides novel stabilizer compositions that provide advantageous features such as the ones outlined above. Specifically, the present invention provides in a first aspect a composition comprising the following components:

(a) a metal complex of a 1,3-diketone; and

(b) an optionally substituted full ester of a monool or a diol and a monocarboxylic acid;

wherein a mixture consisting of (a) and (b) has a viscosity of less or equal than 40 mPa·s when measured at 80° C.

Also provided is a thermoplastic polymer composition comprising a composition according to the invention and, as component (c), a thermoplastic polymer.

The invention further provides a molded or extruded article comprising a composition according to the invention.

The invention also relates in a further aspect to a method for producing a stabilizer composition according to the invention wherein the method comprises the steps:
(i) providing a melted optionally substituted full ester (b); and
(ii) adding to the melt of (i) a 1,3-diketone as described in the invention and a metal oxide or metal hydroxide of a metal as described in the invention.

A further aspect of the invention relates to a method for producing a molded or extruded article, comprising the steps:

I) providing a thermoplastic polymer composition according to the invention;

II) heating the composition to at least 5° C. below the glass transition temperature of the thermoplastic polymer or to a temperature above the glass transition temperature of the thermoplastic polymer;

III) producing a molded, calendered or extruded article from the heated composition.

The invention also concerns the use of a composition according to the invention as a stabilizer for a thermoplastic polymer, preferably as a stabilizer for polyvinyl chloride.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Some documents are cited throughout the text of this specification. Each of the documents cited herein (including all patents, patent applications, scientific publications, manufacturer's specifications, instructions, DIN norms etc.), whether supra or infra, are hereby incorporated by reference in their entirety. Nothing herein is to be construed as an admission that the invention is not entitled to antedate such disclosure by virtue of prior invention.

In the following definitions of the chemical terms: “alkyl”, “heteroalkyl”, “cycloalkyl”, “heterocycloalkyl”, “alicyclic system”, “aryl”, “aralkyl”, “heteroaryl”, “heteroaralkyl”, “alkenyl”, “cycloalkenyl”, “alkynyl” and “optionally substituted” are provided. These terms will in each instance of its use in the remainder of the specification have the respectively defined meaning and preferred meanings.

The term “alkyl” refers to a saturated straight or branched carbon chain. Preferably, an alkyl as used herein is a C,-C20 alkyl and more preferably is a C₁-C₁₀ alkyl, i.e. having 1, 2, 3, 4, 5, 6, 7, 8, 9 or 10 carbon atoms, e.g. is selected from methyl, ethyl, propyl, iso-propyl, butyl, iso-butyl, tert-butyl, pentyl or hexyl, heptyl, octyl, nonyl and decyl. Alkyl groups are optionally substituted.

The term “alcohol” refers to a compound having one or more hydroxyl groups. For example a C8-C₃₆ alkyl alcohol is a C₈-C₃₆ alkyl substituted with one or more hydroxyl groups and preferably with one or two hydroxyl groups.

The term “heteroalkyl” refers to a saturated straight or branched carbon chain. Preferably, the chain comprises from 1 to 9 carbon atoms, i.e. 1, 2, 3, 4, 5, 6, 7, 8, 9 e.g. methyl, ethyl, propyl, iso-propyl, butyl, iso-butyl, sec-butyl, tert-butyl, pentyl or hexyl, heptyl, octyl, which is interrupted one or more times, e.g. 1, 2, 3, 4, 5, with the same or different heteroatoms. Preferably the heteroatoms are selected from 0, S, and N, e.g. -0-CH₃, —S—CH₃, —CH₂—O—CH₃, —CH2—O—C2H5, —CH₂—S—CH₃, —CH₂—S—C₂H₅, —C₂H₄—O—CH₃, —C₂H₄—S—C₂H₅ etc. Heteroalkyl groups are optionally substituted.

The terms “cycloalkyl” and “heterocycloalkyl”, by themselves or in combination with other terms, represent, unless otherwise stated, cyclic versions of “alkyl” and “heteroalkyl”, respectively, with preferably 3, 4, 5, 6, 7, 8, 9 or 10 atoms forming a ring, e.g. cyclopropyl, cyclobutyl, cyclopentyl, cyclohexyl, cycloheptyl, cyclooctyl etc. The terms “cycloalkyl” and “heterocycloalkyl” are also meant to include bicyclic, tricyclic and polycyclic versions thereof. If more than one cyclic ring is present such as in bicyclic, tricyclic and polycyclic versions, then these rings may also comprise one or more aryl- or heteroaryl ring. The term “heterocycloalkyl” preferably refers to a saturated ring having five members of which at least one member is a N, 0 or S atom and which optionally contains one additional 0 or one additional N; a saturated ring having six members of which at least one member is a N, 0 or S atom and which optionally contains one additional 0 or one additional N or two additional N atoms; or a saturated bicyclic ring having nine or ten members of which at least one member is a N, 0 or S atom and which optionally contains one, two or three additional N atoms. “Cycloalkyl” and “heterocycloalkyl” groups are optionally substituted. Additionally, for heterocycloalkyl, a heteroatom can occupy the position at which the heterocycle is attached to the remainder of the molecule. Preferred examples of cycloalkyl include cyclopropyl, cyclobutyl, cyclopentyl, cyclohexyl, cycloheptyl, cyclooctyl, cyclononyl, cyclodecyl, spiro [3,3]heptyl, spiro [3,4]octyl, spiro[4,3]octyi, spiro [3,5]nonyl, spiro[5,3] nonyl, spiro[3,6]decyl, spiro[6,3]decyl, spiro[4,5]decyl, spiro[5,4]decyl, bicyclo[4.1.0]heptyl, bicyclo[3.2.0]heptyl, bicyclo[2.2.1]heptyl, bicyclo[2.2.2]octyl, bicyclo[5.1.0]octyl, bicyclo[4.2.0]octyl, octahydro-pentalenyl, octahydro-indenyl, decahydro-azulenyl, adamantly, or decahydro-naphthalenyl. Examples of heterocycloalkyl include 1-(1,2,5,6- tetrahydropyridyl), 1-piperidinyl, 2-piperidinyl, 3-piperidinyl, 4-morpholinyl, 3-morpholinyl, 1,8 diaza-spiro-[4,5] decyl, 1,7 diaza-spiro-[4,5] decyl, 1,6 diaza-spiro-[4,5] decyl, 2,8 diazaspiro[4,5] decyl, 2,7 diaza-spiro[4,5] decyl, 2,6 diaza-spiro[4,5] decyl, 1,8 diaza-spiro-[5,4] decyl, 1,7 diaza-spiro-[5,4] decyl, 2,8 diaza-spiro-[5,4] decyl, 2,7 diaza-spiro[5,4] decyl, 3,8 diaza-spiro[5,4] decyl, 3,7 diaza-spiro[5,4] decyl, 1-aza-7,11-dioxo-spiro[5,5] undecyl, 1,4-diazabicyclo[2.2.2]oct-2-yl,tetrahydrofuran-2-yl, tetrahydrofuran-3-yl, tetrahydrothien-2-yl, tetrahydrothien-3-yl, 1-piperazinyl, 2-piperazinyl, and the like.

The term “alicyclic system” refers to mono, bicyclic, tricyclic or polycyclic version of a cycloalkyl or heterocycloalkyl comprising at least one double and/or triple bond. However, an alicyclic system is not aromatic or heteroaromatic, i.e. does not have a system of conjugated double bonds/free electron pairs. Thus, the number of double and/or triple bonds maximally allowed in an alicyclic system is determined by the number of ring atoms, e.g. in a ring system with up to 5 ring atoms an alicyclic system comprises up to one double bond, in a ring system with 6 ring atoms the alicyclic system comprises up to two double bonds. Thus, the “cycloalkenyl” as defined below is a preferred embodiment of an alicyclic ring system. Alicyclic systems are optionally substituted.

The term “aryl” preferably refers to an aromatic monocyclic ring containing 6 carbon atoms, an aromatic bicyclic ring system containing 10 carbon atoms or an aromatic tricyclic ring system containing 14 carbon atoms. Examples are phenyl, naphtyl or anthracenyl. The aryl group is optionally substituted.

The term “aralkyl” refers to an alkyl moiety, which is substituted by aryl, wherein alkyl and aryl have the meaning as outlined above. An example is the benzyl radical. Preferably, in this context the alkyl chain comprises from 1 to 8 carbon atoms, i.e. 1, 2, 3, 4, 5, 6, 7, or 8, e.g. methyl, ethyl methyl, ethyl, propyl, iso-propyl, butyl, iso-butyl, sec-butenyl, tert-butyl, pentyl or hexyl, pentyl, octyl. The aralkyl group is optionally substituted at the alkyl and/or aryl part of the group.

The term “heteroaryl” preferably refers to a five or six-membered aromatic monocyclic ring wherein at least one of the carbon atoms are replaced by 1, 2, 3, or 4 (for the five membered ring) or 1, 2, 3, 4, or 5 (for the six membered ring) of the same or different heteroatoms, preferably selected from 0, N and S; an aromatic bicyclic ring system wherein 1, 2, 3, 4, 5, or 6 carbon atoms of the 8, 9, 10, 11 or 12 carbon atoms have been replaced with the same or different heteroatoms, preferably selected from 0, N and S; or an aromatic tricyclic ring system wherein 1, 2, 3, 4, 5, or 6 carbon atoms of the 13, 14, 15, or 16 carbon atoms have been replaced with the same or different heteroatoms, preferably selected from O, N and S. Examples are oxazolyl, isoxazolyl, 1,2,5-oxadiazolyl, 1,2,3-oxadiazolyl, pyrrolyl, imidazolyl, pyrazolyl, 1,2,3-triazoyl, thiazolyl, isothiazolyl, 1,2,3,-thiadiazolyl, 1,2,5-thiadiazolyl, pyridinyl, pyrimidinyl, pyrazinyl, 1,2,3-triazinyl, I,2,4-triazinyl, I,3,5-triazinyl, I-benzofuranyl, 2-benzofuranyl, indolyl, isoindolyl, benzothiophenyl, 2-benzothiophenyl, IH-indazolyl, benzimidazolyl, benzoxazolyl, indoxazinyl, 2,1-benzisoxazoyl, benzothiazolyl, 1,2-benzisothiazolyl, 2,1-benzisothiazolyl, benzotriazolyl, quinolinyl, isoquinolinyl, quinoxalinyl, quinazolinyl, 1,2,3-benzotriazinyl, or 1,2,4-benzotriazinyi.

The term “heteroaralkyl” refers to an alkyl moiety, which is substituted by heteroaryl, wherein alkyl and heteroaryl have the meaning as outlined above. An example is the 2-alklypyridinyl, 3-alkylpyridinyl, or 2-methylpyridinyl. Preferably, in this context the alkyl chain comprises from 1 to 8 carbon atoms, i.e. 1, 2, 3, 4, 5, 6, 7, or 8, e.g. methyl, ethyl methyl, ethyl, propyl, iso-propyl, butyl, iso-butyl, sec-butenyl, tert-butyl, pentyl or hexyl, pentyl, octyl. The heteroaralkyl group is optionally substituted at the alkyl and/or heteroaryl part of the group.

The terms “alkenyl” and “cycloalkenyl” refer to olefinic unsaturated carbon atoms containing chains or rings with one or more double bonds. Examples are propenyl and cyclohexenyl. Preferably, the alkenyl chain comprises from 2 to 8 carbon atoms, i.e. 2, 3, 4, 5, 6, 7, or 8, e.g. ethenyl, 1-propenyl, 2-propenyl, iso-propenyl, 1-butenyl, 2-butenyl, 3-butenyl, iso-butenyl, sec-butenyl, 1-pentenyl, 2-pentenyl, 3-pentenyl, 4-pentenyl, hexenyl, heptenyl, octenyl. The term also comprises CH₂, i.e. methenyl, if the substituent is directly bonded via the double bond. Preferably the cycloalkenyl ring comprises from 3 to 14 carbon atoms, i.e. 3, 4, 5, 6, 7, 8, 9, 10, 11, 12, 13 or 14, e.g. cyclopropenyl, cyclobutenyl, cyclopentenyl, cyclohexenyl, cycloheptenyl, cyclooctyl, cyclononenyl, cyclodecenyl, spiro[3,3]heptenyl, spiro[3,4]octenyl, spiro[4,3]octenyl, spiro[3,5]nonenyl, spiro[5,3]nonenyl, spiro[3,6]decenyl, spiro[6,3]decenyl, spiro[4,5]decenyl, spiro[5,4]decenyl, bicyclo[4.1.0]heptenyl, bicyclo[3.2.0]heptenyl, bicyclo[2.2.1]heptenyl, bicyclo[2.2.2]octenyl, bicyclo[5.1.0]octenyl, bicyclo[4.2.0]octenyl, hexahydro-pentalenyl, hexahydro-indenyl, octahydro-azulenyl, or octahydro-naphthalenyl.

The term “alkynyl” refers to unsaturated carbon atoms containing chains or rings with one or more triple bonds. An example is the propargyl radical. Preferably, the alkynyl chain comprises from 2 to 8 carbon atoms, i.e. 2, 3. 4, 5, 6, 7, or 8, e.g. ethynyl, 1-propynyl, 2-propynyl, 1-butyryl, 2-butyryl, 3-butyryl, 1-pentynyl, 2-pentynyl, 3-pentynyl, 4-pentynyl, hexynyl, pentynyl, octynyl.

The term “optionally substituted” in each instance if not further specified refers to between 1 and 10 substituents, e.g. 1, 2, 3, 4, 5, 6, 7, 8, 9, or 10 substituents which are in each instance independently selected from the group consisting of halogen, in particular F, Cl, Br or I; —NO₂, —CN, —OR′, —NR′R″, —(CO)OR′, —(CO)OR′″, —(CO)NR′R″, —NR′COR″″, NR′COR′, —NR″CONR′R″, —NR″SO₂A, —COR′″; —SO₂NR′R″, —OOCR′″, CR′″R″″OH, —R′″OH, and -E;

R′ and R″ is each independently selected from the group consisting of hydrogen, alkyl, alkenyl, alkynyl, -OE, cycloalkyl, heterocycloalkyl, aryl, heteroaryl, and aralkyl or together form a heteroaryl, or heterocycloalkyl; optionally substituted;

R′″ and R″″ is each independently selected from the group consisting of alkyl, alkenyl, alkynyl, cycloalkyl, heterocycloalkyl, alkoxy, aryl, aralkyl, heteroaryl, and —NR′R″;

E is selected from the group consisting of alkyl, alkenyl, cycloalkyl, alkoxy, alkoxyalkyl, heterocycloalkyl, an alicyclic system, aryl and heteroaryl; optionally substituted;

If two or more radicals can be selected independently from each other, then the term “independently” means that the radicals may be the same or may be different.

As used herein the term “full ester” means that during ester synthesis preferably all free hydroxyl groups of the alcohol reactant are reacted with a monocarboxylic acid such that there are no free hydroxyl groups on the alcohol part of the full ester. The full ester of the invention preferably has a hydroxyl number of less than 25, less than 15 or less than 10. Most preferably the full ester used in the invention has a hydroxyl number of 0, i.e. most preferably the full ester of said diol and a monocarboxylic acid is a diester.

The present invention provides novel stabilizer compositions for thermoplastic polymers such as halogenated polyolefins and in particular for polyvinyl chloride. It is preferable that the novel stabilizer compositions according to the invention have a low viscosity such that they can effectively be handled and confectioned.

It was unexpectedly found that stabilizer compositions for thermoplastic polymers that have the desired low viscosity can be prepared using an optionally substituted full ester of a monool or diol and a monocarboxylic acid as a single carrier. This provides the advantage that additional solvents which were required in prior art stabilizer compositions such as hydrocarbon wax can be left out, saving resources. The inventive stabilizer composition furthermore does not require any toxic metals such as lead, tin, barium and cadmium as co-stabilizers although the addition of such metal ions is in all embodiments optional. Preferably, however, a stabilizer composition of the invention does not comprise any metal selected from the list consisting of tin, lead, barium and cadmium. Furthermore, it is expected that the inventive stabilizer compositions when admixed to thermoplastic polymers such as PCV will result in a thermoplastic polymer composition which has a stable and persistent early color (i.e. a reduced occurrence of any discoloring over time of the thermoplastic polymer composition comprising the composition of the invention) and which has no discoloration at relatively high temperatures for the period of time required for the production of shaped articles.

The invention provides such composition in the first aspect which is a composition comprising or consisting of the following components:

(a) a metal complex of a 1,3-diketone; and

(b) an optionally substituted full ester of a monool or diol and a monocarboxylic acid; wherein a mixture consisting of (a) and (b) has a viscosity of less or equal than 40 mPa·s when measured at 80° C.

In one preferred embodiment the composition of the invention comprises or consists of the following components:

(a) a metal complex of a 1,3-diketone; and

(b) a monoester or diester of a monool or diol, respectively, and a monocarboxylic acid;

wherein a mixture consisting of (a) and (b) has a viscosity of less or equal than 40 mPa·s when measured at 80° C.

In one preferred embodiment the composition of the invention comprises or consists of the following components:

(a) a metal complex of a 1,3-diketone; and

(b) a monoester or diester of a monool or diol, respectively, and a monocarboxylic acid;

wherein a mixture consisting of (a) and (b) has a viscosity of less or equal than 30 mPa·s and most preferably less or equal than 25 mPa·s when measured at 80° C.

The combination of the above components unexpectedly produces a composition with a low viscosity of less or equal than 40 mPa·s when measured at 80° C. (see also examples provided herein below). In preferred embodiments, the composition of the invention has a viscosity of less or equal than 35, 30, 25, 20 or less than 15 mPa·s when measured at 80° C.

In this context it is to be understood that as used throughout this specification all viscosity parameters are determined as defined in the standard method disclosed in the September 2008 edition of DIN 53019-1. In this method a rotational viscometer is calibrated and used according to said DIN norm. While the method described in DIN 53019-1 is suitable for measuring viscosities at various temperatures , the viscosity values disclosed in this patent application have been measured at 80° C. The average skilled person is familiar with the method outlined in DIN 53019-1 and able to carry out this method.

In a preferred embodiment, the metal in (a) of the composition of the invention is a metal cation of group IIA or group IIB and preferably a metal cation selected from magnesium, calcium and zinc.

Surprisingly it was found that a much lower viscosity of the composition could be achieved when using magnesium ions and/or zinc ions. Thus, it is preferred that the metal ion is zinc and/or magnesium. Furthermore, when comparing the storage stability of a thermoplastic polymer composition comprising as component (a) a magnesium complex of a 1,3-diketone with a thermoplastic polymer composition comprising as component (a) a zinc complex of a 1,3-diketone it was found that the composition comprising the magnesium complex unexpectedly had a better storage stability. Thus, it is most preferred that the composition of the invention comprises as component (a) a magnesium complex of a 1,3-diketone.

Preferably the 1,3-diketone in (a) of the composition according to the invention is a diketon according to formula (I)

R₁—C(O)—CH₂—C(O)—R₂ (I)

wherein

R₁ and R₂ are each independently selected from C₁-C₂₀-alkyl, heteroaryl and aryl; optionally substituted.

Preferably, R, and R₂ are each independently selected from Cᵢ-Cᵢo-alkyl (e.g. methyl, ethyl, propyl, iso-propyl, butyl, iso-butyl, tort-butyl, pentyl or hexyl, heptyl, octyl, nonyl or decyl), heteroaryl and aryl; optionally substituted. If R, and/or R₂ is aryl, they are each individually selected preferably from phenyl and benzyl; optionally halogenated. Preferred 1,3-diketones are also diketons according to formula (I), wherein

R₁ and R₂ are each independently selected from C₁-C₆-alkyl (e.g. methyl, ethyl, propyl, iso-propyl, butyl, iso-butyl, tert-butyl, pentyl or hexyl);

where R₁ and R₂ are each independently selected from phenyl or benzyl;

wherein R₁ is stearyl and R₂ is phenyl;

wherein R₁ is stearyl and R₂ is benzyl; or

wherein R₁ is stearyl and R₂ is stearyl.

It is preferred that in the composition of the invention component (a) is a metal acetylacetonate and preferably magnesium acetylacetonate.

As previously mentioned components (a) and (b) are sufficient to provide a composition with a low viscosity. Thus, it is preferred that the composition of the invention comprises components (a) and (h) but does not comprise further solvents such as a paraffin- or polyethylene wax.

In a further preferred embodiment of the composition according to the invention, component (a) is present in an amount of at least 10, 20, 25, 30, 35, 40, 4.5 or at least 50 wt% based on the total weight of components (a) and (b).

Preferably, said monool of the composition of the invention is selected from the group consisting of an unbranched C3-C36 alkyl alcohol, an unbranched C₈-C₃₆ alkenyl alcohol, a branched C₈-C₃₆ alkyl alcohol and a branched C8-C₃₆ alkenyl alcohol. Preferably, the monool is selected from an unbranched C₈-C₁₈ alkyl alcohol, an unbranched C₈-C₁₈ alkenyl alcohol, a branched C₈-C₁₈ alkyl alcohol and a branched C8-C18 alkenyl alcohol. As diol in the composition of the invention is preferred a diol that is selected from the group consisting of glycol, diethylene glycol, triethylene glycol, PEG and a compound according to formula (II):

HO—CH₂—R₃—CH₂—OH

wherein R₃ is selected from C₁-C₄ alkyl (e.g. methyl, ethyl, propyl, iso-propyl, butyl, iso-butyl and tert-butyl), C₂-C₄ alkenyl and -0-. Preferably, the compound of formula (II) is a compound selected from the group consisting of 1,3-propanediol, 1,4-butanediol, 1,5-pentanediol, 1,6-hexanediol and neopentyl glycol.

The monocarboxylic acid in (b) of the composition according to the invention is preferably an unbranched saturated or unbranched unsaturated monocarboxylic acid.

In a further preferred embodiment of the composition according to the invention said monocarboxylic acid in (b) is a C₈-C₃₆ monocarboxylic acid, more preferably an unbranched saturated C₈-C₂₀ monocarboxylic acid and most preferably an unbranched C₁₂-C₁8 monocarboxylic acid such as lauric acid, myristic acid, palmitic acid, stearic acid, oleic acid, linoleic acid or linolenic acid.

It was found that symmetric diesters performed particularly well in reducing the viscosity of the composition of the invention. Thus, in a further preferred embodiment, the component (b) of the composition of the invention is a symmetric diester and is preferably ethylene glycol dipalmitate or ethylene glycol distearate. In a symmetric diester the acid component of the ester is the same for each hydroxyl group of the alcohol component of the ester.

It is preferred that said monoester and said diester of the composition of the invention do not comprise any aromatic groups and more preferably the mono- or diester of the compositon is saturated.

Also preferred is a composition comprising the following components:
(a) magnesium acetylacetonate; and
(b) an optionally substituted diester of a diol and an unbranched C12- C 18 monocarboxylic acid such as lauric acid, myristic acid, palmitic acid, stearic acid, oleic acid, linoleic acid or linolenic acid; more preferably the ester is ethylene glycol dipalmitate, ethylene glycol distearate or ethylene glycol dimyristate and most preferably the ester is ethylene glycol dipalmitate;
   wherein a mixture consisting of (a) and (b) has a viscosity of less or equal than 40 mPa·s when measured at 80° C.

Also preferred is a composition comprising or consisting of the following components:
(a) magnesium acetylacetonate; and
(b) an optionally substituted diester of a diol and an unbranched C₁₂-C₁₈ monocarboxylic acid such as lauric acid, myristic acid, palmitic acid, stearic acid, oleic acid, linoleic acid or linolenic acid; more preferably the ester is ethylene glycol dipalmitate, ethylene glycol distearate or ethylene glycol dimyristate and most preferably the ester is ethylene glycol dipalmitate
   wherein a mixture consisting of (a) and (b) has a viscosity of less or equal than 25 mPa·s when measured at 80° C.

A further embodiment relates to a composition comprising or consisting of the following components:
(a) magnesium acetylacetonate; and
(b) an optionally substituted diester of a diol and an unbranched C₁₂-C₁₈ monocarboxylic acid such as lauric acid, myristic acid, palmitic acid, stearic acid, oleic acid, linoleic acid or linolenic acid; more preferably the ester is ethylene glycol dipalmitate, ethylene glycol distearate or ethylene glycol dimyristate and most preferably the ester is ethylene glycol dipalmitate.

The composition of the invention may optionally also comprise additional ingredients selected from the group consisting of fillers, cure agents, lubricants, ultraviolet light stabilizers, antioxidants, catalyst stabilizers, flame retardants, antiblock agents, other metal soaps and combinations thereof.

As mentioned above, the composition of the invention has a low viscosity and functions as a stabilizer in various thermoplastic polymers. Thus, in a further aspect, the invention provides a thermoplastic polymer composition comprising a composition according to the invention and, as further component (c), a thermoplastic polymer.

The thermoplastic polymer in said composition is preferably a halogen-containing polymer preferably a halogen polyolefin and preferably polyvinyl chloride. Examples of said halogen-containing polymers are polymers of vinyl chloride, vinyl resins containing vinyl chloride units in the polymer backbone, copolymers of vinyl chloride and vinyl esters of aliphatic acids, especially vinyl acetate, copolymers of vinyl chloride with esters of acrylic and methacrylic acid or acrylonitrile or mixtures of two or more thereof, copolymers of vinyl chloride with diene compounds or unsaturated dicarboxylic acids or anhydrides thereof, for example copolymers of vinyl chloride with diethyl maleate, diethyl fumarate or maleic anhydride, post-chlorinated polymers and copolymers of vinyl chloride, copolymers of vinyl chloride and vinylidene chloride with unsaturated aldehydes, ketones and other compounds such as acrolein, crotonaldehyde, vinyl methyl ketone, vinyl methyl ether, vinyl isobutyl ether and the like, polymers and copolymers of vinylidene chloride with vinyl chloride and other polymerisable compounds, such as those already mentioned above, polymers of vinyl chloroacetate and dichlorodivinyl ether, chlorinated polymers of vinyl acetate, chlorinated polymeric esters of acrylic acid and a-substituted acrylic acids, chlorinated polystyrenes, for example polydichlorostyrene, chlorinated polymers of ethylene, polymers and post-chlorinated polymers of chlorobutadiene and copolymers thereof with vinyl chloride and also mixtures of two or more of the mentioned polymers or polymer mixtures that contain one or more of the above-mentioned polymers. Within the scope of a preferred embodiment of the present invention, the stabiliser compositions according to the invention are used for the production of molded, extruded and/or calendered articles of PVC-U, such as window profiles, industrial profiles, tubes, plates, e.t.c. A molded article is preferably an injection-molded article.

Preferably, the total amount of components (a) and (b) in the thermoplastic polymer composition of the invention is between 0.01 wt % and 5 wt % based on the weight of component (c) and more preferably between 0.5 wt % and 2.5 wt % based on the weight of component (c).

The invention also relates in a further aspect to a method for producing a stabilizer composition according to the invention wherein the method comprises the steps:
(i) providing a melted optionally substituted full ester (b); and
(ii) adding to the melt of (i) a 1,3-diketone as described in the invention and a metal oxide or metal hydroxide of a metal as described in the invention. Preferably the metal is a group IIA or group IIB metal and most preferably the metal is selected from the group consisting of zinc, magnesium or calcium.
   In the method of producing a stabilizer composition of the invention, it does not matter either said 1,3-diketone or said metal oxide or metal hydroxide is added first to the full ester in (i). Alternatively, a mixture of said 1,3-diketone and said metal oxide or metal hydroxide is added to the melt of (i). Optionally the method comprises a further step (iii), wherein the composition obtained from (ii) is stirred at sub-atmospheric pressure such as at a pressure between 200-700 mbar.

In a further aspect the invention relates to a molded, calendered or extruded article comprising a thermoplastic polymer composition according to the invention. The average skilled person can for example use the following method according to the next aspect of the invention for producing said molded or extruded articles. This method comprises the steps:
I) providing a thermoplastic polymer composition according to the invention;
II) heating the composition to at least 5° C. below the glass transition temperature of the thermoplastic polymer or to a temperature above the glass transition temperature of the thermoplastic polymer;
III) producing a molded, calendered or extruded article from the heated composition.

In one embodiment of this method the composition according to the invention is heated and mixed in a first step at about 120° C. and then melted in step II to produce a mass suitable for extrusion and/or the preparation of a molded article. Depending on the thermoplastic polymer the temperatures used can be optimized to minimize thermal decomposition of the polymer. For example in a preferred embodiment of the method of the invention, in step (II) a temperature between 1° C. below the glass transition temperature of the polymer and 25° C. above the glass temperature of the thermoplastic polymer is applied.

As mentioned the composition of the invention is suitable to be used as stabilizer. Thus, a further aspect of the invention concerns the use of a composition according to the invention as a stabilizer for a thermoplastic polymer, preferably for a halogen-containing polymer as outlined above and most preferably as a stabilizer for polyvinyl chloride.

Various modifications and variations of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in the relevant fields are intended to be covered by the present invention.

The following figures and examples are merely illustrative of the present invention and should not be construed to limit the scope of the invention as indicated by the appended claims in any way.

### EXAMPLES

### Example 1

### Production and Testing of Stabilizer Compositions Production of Zinc Actylacetonate (40%) in Ethyleneglycol di-C16/18 Ester

198 g of ethylene glycol di C 16/18 ester (a non-symmetric ester) were placed into a 500 ml flask and heated to 115° C. To the melt 110.4 g of acetylacetonate and 40.8 g of zinc oxide was added in 3 portions. Following the addition of each portion the mixture was stirred at atmospheric pressure for 30 min and thereafter at a pressure of 400 mbar for again 30 min. In the end the mixture was dried at 29 mbar for 30 minutes. The yield was 307.5 g.

| | | | | Vis- |
|---|---|---|---|---|
| Exam- | | wt % of metal | Dropping- | cosity |
| ple | Lubricant | acetylacetonate | point ° C. | 80° C. |
| 1 | Ethyleneglycol C16/18 ester | 40% Zn | 66.2 | 38 |
| 2 | hydrogenated castor oil | 40% Zn | 51.2 | 174 |
| 3 | Pentaerythritoltetra | 40% Zn | 86 | 44 |
| | C16/18 ester | | | |
| 4 | Ester composition based | 40% Zn | 84 | 22 |
| | on C₁₆ and C₁₈ fatty acids | | | |
| | as acid component and | | | |
| | C₁₆ and C₁₈ monools as | | | |
| | alcohol component. | | | |
| 5 | hardened tallow | 40% Zn | 67 | 29 |
| 6 | Ethyleneglycoldipalmitate | 40% Zn | 69.4 | 11 |
| 7 | Ethyleneglycoldipalmitate | 25% Ca | | 101 |
| 8 | Pentaerythritol di | 25% Ca | | >500 |
| | C16/18 ester | | | |
| 9 | Ethyleneglycoldipalmitate | 40% Mg | 70.5 | 25 |
| 10 | Ethyleneglycoldipalmitate | 30% Mg | 70.3 | 11 |

The amount of ash at 1000° C. in the product was 9.3%.

Analogous to the above outlined method also the compositions for examples 2-10 as outlined in the following table have been prepared. All compositions have been tested for their dropping point and viscosity as also outlined in the table below:

In the above table, “wt % of metal acetylacetonate” refers to the weight amount of the respectively indicated metal acetylacetonate as comprised in the final composition that comprises said lubricant and said metal acetylacetonate.

The dropping point of each composition has been measured according to the method described in DIN ISO 2176:1997-05.

### Example 2

### Stabilization of a PVC Polymer

The average skilled person is familiar with methods of producing stabilized thermoplastic polymer composition comprising a stabilizer composition. In one embodiment such stabilized thermoplastic polymer compositions can be prepared analogously to the methods outlined in EP 0 686 139 A1, EP 0 336 289 and U.S. Pat. No. 5,010,123, except that a stabilizer composition according to the present invention is employed.

1. A composition comprising the following components:
(a) a metal complex of a 1,3-diketone; and
(b) an optionally substituted full ester of a monool or a diol and a monocarboxylic acid;
wherein a mixture consisting of (a) and (b) has a viscosity of less or equal than 40 mPa·s when measured at 80° C.

2. The composition according to claim 1, wherein the metal in (a) is a metal cation of group IIA or IIB.

3. The composition according to claim 1, wherein the 1,3-diketone in (a) is a diketon according to formula (I)
R₁—C(O)—CH₂—C(O)—R₂ (I)
wherein
R₁ and R₂ are each independently selected from C₁-C₂₀-alkyl, heteroaryl and aryl; optionally substituted.

4. The composition according to claim 1, wherein component (a) is magnesium acetylacetonate.

5. The composition according to claim 1, wherein component (a) is present in an amount of at least 10 wt % based on the total weight of components (a) and (b).

6. The composition according to claim 1, wherein the monool is an unbranched C₂-C₃₆ alkyl alcohol or an unbranched C₈-C₃₆ alkenyl alcohol; and
the diol is selected from the group consisting of glycol, diethylene glycol, triethylene glycol, PEG and a compound according to formula (II):
HO—CH₂—R₃—CH₂—OH (II)
wherein
R₃ is selected from C₁-C₄ alkyl, C₂-C₄ alkenyl and —O—.

7. The composition according to claim 1, wherein said monocarboxylic acid in (b) is an unbranched saturated or unbranched unsaturated monocarboxylic acid and preferably is an unbranched saturated C₈-C₃₆ monocarboxylic acid or an unbranched unsaturated C₃-C₃₆ monocarboxylic acid.

8. The composition according to claim 1, wherein component (b) is a symmetric diester.

9. A thermoplastic polymer composition comprising a composition according to claim 1 further comprising component (c), a thermoplastic polymer.

10. The thermoplastic polymer composition according to claim 9, wherein the thermoplastic polymer is a halogenated polyolefin.

11. The thermoplastic polymer composition according to claim 9, wherein the total amount of components (a) and (b) is between 0.01 wt % and 5 wt % based on the weight of component (c).

12. A molded, calendered or extruded article comprising a thermoplastic polymer composition according to claim 9.

13. A method for producing a composition according to claim 1 comprising the steps:
(i) providing a melted optionally substituted full ester (b) as described in claims 1-8; and
(ii) adding to the melt of (i) a 1,3-diketone as described in claims 1-8 and a metal oxide or metal hydroxide of wherein the metal is from group IIA or group IIB.

14. A molded for producing a molded or extruded article, comprising the steps:
I) providing a thermoplastic polymer composition according to claim 1;
II) heating the composition to at least 5° C. below the glass transition temperature of the thermoplastic polymer or to a temperature above the glass transition temperature of the thermoplastic polymer; and
III) producing a molded, calendered or extruded article from the heated composition.

15. Use of a composition according to claim 1 as a stabilizer for a thermoplastic polymer.

16. The composition according to claim 1, wherein the metal in (a) is a metal cation selected from magnesium, calcium and zinc.

17. The composition according to claim 1, wherein component (b) is selected from ethylene glycol dipalmitate or ethylene glycol distearate.

18. The thermoplastic polymer composition according to claim 9, wherein the thermoplastic polymer is polyvinyl chloride.
